(19) United States
(12) Patent Application Publication
(10) Pub. No.: US 2011/0232826 A1
(43) Pub. Date: Sep. 29, 2011

(54) PRODUCTION METHOD FOR CERAMIC-RESIN COMPOSITE

(75) Inventors: Tomoyuki HARA, Tsukuba-shi (JP); Mitsuo MAEDA, Tsukuba-shi (JP); Hisashi SUZUKI, Tsukuba-shi (JP); Hideaki NEZU, Ichikawa-shi (JP)

(73) Assignee: SUMITOMO CHEMICAL COMPANY, LIMITED, Tokyo (JP)

(21) Appl. No.: 13/050,422

(22) Filed: Mar. 17, 2011

(30) Foreign Application Priority Data
Mar. 26, 2010 (JP) P2010-072397

(51) Int. Cl. B29C 65/08

(52) U.S. Cl. 156/73.1

(57) ABSTRACT

A production method for a ceramic-resin composite, comprising a welding step of ultrasonically welding a ceramic component and a thermoplastic resin component, wherein at the welding step, at least one of the ceramic component and the thermoplastic resin component has been heated.

### BACKGROUND OF THE INVENTION

1. Field of the Invention

The present invention relates to a production method for a ceramic-resin composite formed of a ceramic component and a thermoplastic resin component.

2. Related Background Art

Ceramic-resin composites formed of a ceramic component and a thermoplastic resin component are used for various components such as controlling circuit components such as sensor components, lighting components, and inverters, and communication components in broad industrial fields including home appliances (air-conditioners, television receivers, personal computers, refrigerators, washing machines, other electric and electronic apparatuses, and the like) and automobiles (four-wheeled cars, three-wheeled cars, motorcycles, and the like).

Such a ceramic-resin composite is produced by joining a ceramic component and a thermoplastic resin component to each other. Because materials of different kinds (a ceramic and a thermoplastic resin) are joined to each other, however, joining strength may be reduced compared with joining of materials of the same kind, and may be less than base material strength. Therefore, improvement of this point has been demanded.

To meet such a demand, joining of a ceramic component and a thermoplastic resin component by ultrasonic welding is disclosed (for example, see Japanese Unexamined Patent Application Publication No. 2002-237240, especially claims 1 to 3). Further, provision of a porous region on the surface of a ceramic component and provision of a projection part in a thermoplastic resin component, and ultrasonic welding of the porous region of the ceramic component and the projection part of the thermoplastic resin component are disclosed (for example, see Japanese Unexamined Patent Application Publication No. 2007-55228, especially claims 1 and 4, and paragraph [0037]).

### SUMMARY OF THE INVENTION

However, because the ceramic and the thermoplastic resin usually have melting temperatures different from each other, joining strength of the welding surface is not always sufficient when the ceramic component and the thermoplastic resin component are merely ultrasonically welded to each other according to the technique proposed in Japanese Unexamined Patent Application Publication No. 2002-237240. When the applied energy of ultrasonic vibration is increased in order to increase the joining strength of the welding surface, the thermoplastic resin excessively melts; for this reason, the size of the thermoplastic resin component is fluctuated or a large amount of burrs is produced. Accordingly, there has been inconvenience that a ceramic-resin composite having high dimensional precision cannot be obtained.

On the other hand, in the technique proposed in Japanese Unexamined Patent Application Publication No. 2007-55228, it is necessary to prepare a ceramic component having a porous region on the surface thereof prior to ultrasonic welding; difficulties accompany the case of producing such a ceramic component, and the ceramic component is expensive even if this is acquired. For that reason, there has been inconvenience that the ceramic-resin composite cannot be produced at low cost.

Then, an object of the present invention is to provide a production method for a ceramic-resin composite, with which joining strength between a ceramic component and a thermoplastic resin component can be increased without such inconvenience.

The present invention provides [1] to [5] below.

[1] A production method for a ceramic-resin composite, comprising a welding step of ultrasonically welding a ceramic component and a thermoplastic resin component, wherein at the welding step, at least one of the ceramic component and the thermoplastic resin component has been heated.

[2] The method according to [1], wherein at the welding step, the ceramic component has been heated within a temperature range from a lower limit temperature 100° C. lower than a flow initiation temperature of a thermoplastic resin that forms the thermoplastic resin component to an upper limit temperature 100° C. higher than the flow initiation temperature.

[3] The method according to [1], wherein at the welding step, the thermoplastic resin component has been heated within a temperature range from a lower limit temperature 100° C. lower than the flow initiation temperature of a thermoplastic resin that forms the thermoplastic resin component to an upper limit temperature 10° C. higher than the flow initiation temperature.

[4] The method according to any one of [1] to [3], wherein the flow initiation temperature of the thermoplastic resin that forms the thermoplastic resin component is 250 to 350° C.

[5] The method according to any one of [1] to [4], wherein the thermoplastic resin component is formed of a liquid crystal polyester.

According to the present invention, joining strength between the ceramic component and the thermoplastic resin component can be increased. In addition, because the cost of heating at least one of the ceramic component and the thermoplastic resin component is relatively low, a ceramic-resin composite having high dimensional precision can be produced at low cost.

### BRIEF DESCRIPTION OF THE DRAWINGS

FIG. 1 is a schematic cross-sectional view showing an example of a ceramic-resin composite according to the embodiment 1.

FIG. 2 is a process chart illustrating a production method for a ceramic-resin composite according to the embodiment 1; (a) is a schematic cross-sectional view illustrating a heating step, and (b) is a schematic cross-sectional view illustrating a welding step.

### DESCRIPTION OF THE EMBODIMENTS

Hereinafter, an embodiment according to the present invention will be described.

### Embodiment 1 of the Invention

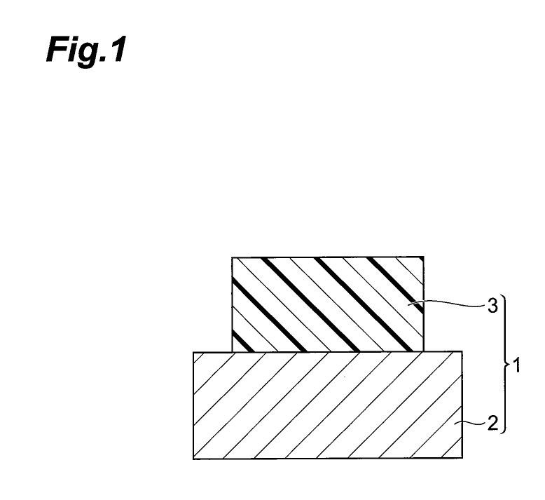

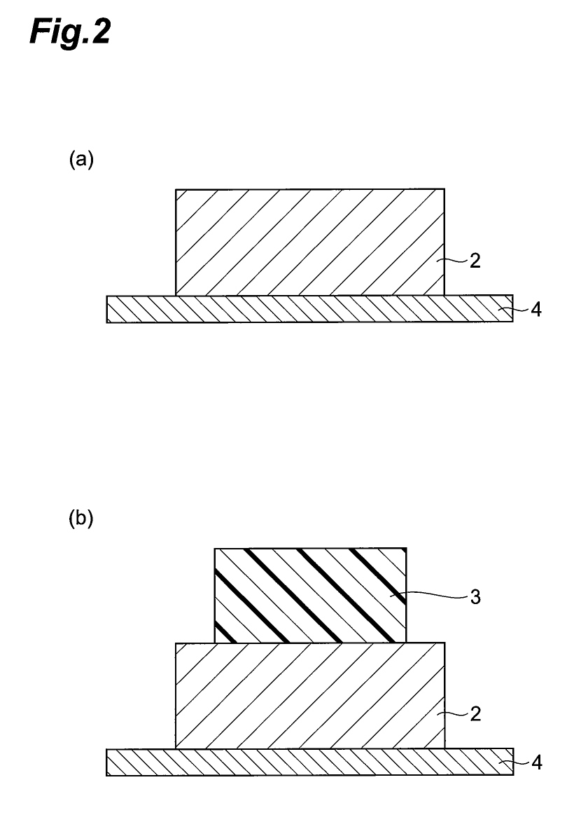

Hereinafter, a configuration of a ceramic-resin composite and a production method therefor of the embodiment 1 will be described sequentially based on FIGS. 1 and 2.

<Configuration of Ceramic-Resin Composite>

FIG. 1 is a schematic cross-sectional view showing an example of a ceramic-resin composite according to the embodiment 1. The ceramic-resin composite 1 in FIG. 1 is formed by integrally joining a ceramic component 2 and a thermoplastic resin component 3 to each other by ultrasonic welding.

The ceramic component 2 is a component formed of a ceramic containing one or more constituents selected from the group consisting of alumina, magnesia, zirconia, silicon carbide, silicon nitride, aluminium nitride, and boron nitride as a principal constituent. Preferably, the ceramic component 2 is a component formed of a ceramic containing not less than 75% by mass of alumina. More preferably, the ceramic component 2 is a component formed of a ceramic containing not less than 90% by mass of alumina. The ceramic component 2 can be produced from these ceramics by a known method (for example, sintering or the like).

While surface roughness (arithmetic mean roughness) Ra of the ceramic component 2 is usually 0.1 to 1 μm, the surface thereof may be roughened by a physical process such as sandblasting or a chemical process such as etching in order to increase welding strength by ultrasonic welding to the thermoplastic resin component 3.

On the other hand, the thermoplastic resin component 3 is a component formed of a thermoplastic resin containing one or more resins selected from the group consisting of polyethylenes, polypropylenes, polystyrenes, ABS (acrylonitrile-butadiene-styrene)s, polyvinyl chlorides, polycarbonates, polyamides, polyacetals, polybutylene terephthalates, polyethylene terephthalates, polyphenylene sulfides, polyethersulfones, liquid crystal polyesters, polyimides, syndiotactic polystyrenes, and polycyclohexane dimethylene terephthalates as a principal constituent. Preferably, the thermoplastic resin component 3 is a component formed of a thermoplastic resin containing one or more resins selected from the group consisting of polyacetals, polybutylene terephthalates, polyethylene terephthalates, polyphenylene sulfides, polyamides, liquid crystal polyesters, polyimides, syndiotactic polystyrenes, and polycyclohexane dimethylene terephthalates as a principal constituent, which are easy to mold and process, and excellent in electrical properties, mechanical properties and heat resistance. More preferably, the thermoplastic resin component 3 is a component formed of a thermoplastic resin containing a liquid crystal polyester as a principal constituent.

Preferably, the thermoplastic resin component 3 is a component formed of a thermoplastic resin containing not less than 40% by mass of the above mentioned principal constituent. More preferably, the thermoplastic resin component 3 is a component formed of a thermoplastic resin containing not less than 60% by mass of the above mentioned principal constituent.

Here, it is preferable that the flow initiation temperature of the thermoplastic resin be 250° C. to 350° C., and more preferably not less than 280° C. This flow initiation temperature refers to a temperature at which a melt viscosity is 4800 Pa·s when using a capillary tube rheometer having a nozzle whose inner diameter is 1 mm and length is 10 mm, the hot melt is extruded from the nozzle at a heating rate of 4° C./min under load of 9.8 MPa. This flow initiation temperature is an index indicating a molecular weight of the thermoplastic resin such as liquid crystal polyester (for example, see “Ekishopolymer—Gousei, Seikei, Ouyo—(Liquid Crystal Polymer—Synthesis, Molding and Application—),” edited by Naoyuki Koide, pages 95 to 105, CMC, published on Jun. 5, 1987).

Then, the thermoplastic resin component 3 can be produced from these thermoplastic resins by a known method (for example, an injection molding method, or the like).

The above liquid crystal polyester is a polyester also called as a thermotropic liquid crystal polymer, and forms a melt showing anisotropy optically at 450° C. or less. Typical examples thereof include (1) to (4) below.

(1): Liquid crystal polymers in which an aromatic hydroxycarboxylic acid, an aromatic dicarboxylic acid, and an aromatic diol are copolymerized.
(2): Liquid crystal polymers in which aromatic hydroxycarboxylic acids of different kinds are copolymerized.
(3): Liquid crystal polymers in which an aromatic dicarboxylic acid and an aromatic diol are copolymerized.
(4): Liquid crystal polymers in which an aromatic hydroxycarboxylic acid is reacted with a crystal polyester such as polyethylene terephthalate.

Instead of these aromatic hydroxycarboxylic acids, aromatic dicarboxylic acids, or aromatic diols, ester forming derivatives thereof may be used. Here, examples of the ester forming derivatives of aromatic hydroxycarboxylic acids or aromatic dicarboxylic acids include an acid halide, an acid anhydride, an ester, or the like. The acid halide or an acid anhydride corresponds to the one in which the carboxyl group of an aromatic hydroxycarboxylic acid or an aromatic dicarboxylic acid is converted into a highly reactive haloformyl group or acyloxy carbonyl group. The ester corresponds to the one in which the carboxyl group of an aromatic hydroxycarboxylic acid or an aromatic dicarboxylic acid forms an ester group with alcohols, ethylene glycol, or the like such that a polyester may be produced by a transesterification reaction.

Moreover, examples of the ester forming derivatives of aromatic hydroxycarboxylic acid or aromatic diol include an ester in which a phenolic hydroxyl group of the aromatic hydroxycarboxylic acid or the aromatic diol forms an ester group with a lower carboxylic acid such that a polyester may be produced by a transesterification reaction.

The aromatic hydroxycarboxylic acid, the aromatic dicarboxylic acid, or the aromatic diol may have one or more halogen atoms such as chlorine atoms and fluorine atoms, alkyl groups such as methyl groups and ethyl groups, and aryl groups such as phenyl groups as substituents in an aromatic ring thereof, for example, if the substituents are included at an extent in which the substituents do not obstruct ester formation.

Examples of the structural units derived from the aromatic hydroxycarboxylic acid include those represented in Chemical Formula 1:

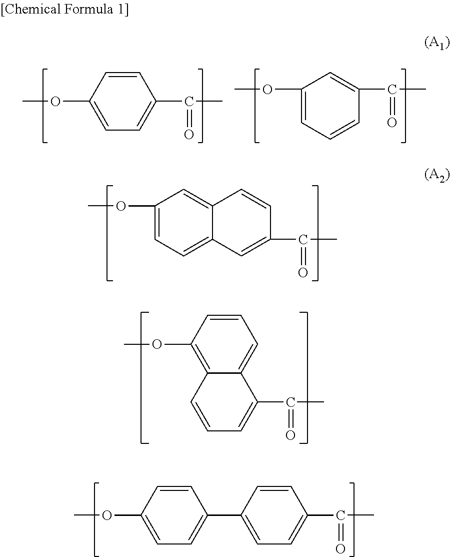

In the structural units, examples of the structural units derived from the aromatic hydroxycarboxylic acid also include those having one or more halogen atoms, alkyl groups, or aryl groups as substituents.

Examples of the structural units derived from the aromatic dicarboxylic acid include those represented by Chemical Formula 2:

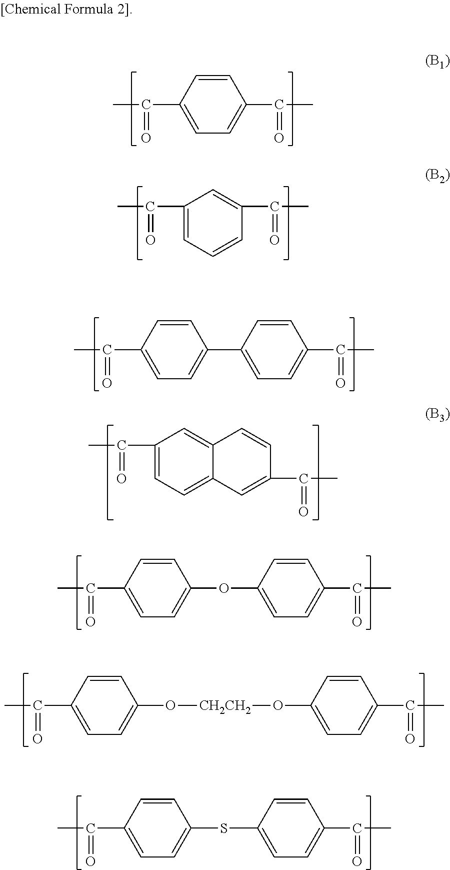

In the structural units, examples of the structural units derived from the aromatic dicarboxylic acid also include those having one or more halogen atoms, alkyl groups, or aryl groups as substituents.

Examples of the structural units derived from the aromatic diol include those represented by Chemical Formula 3:

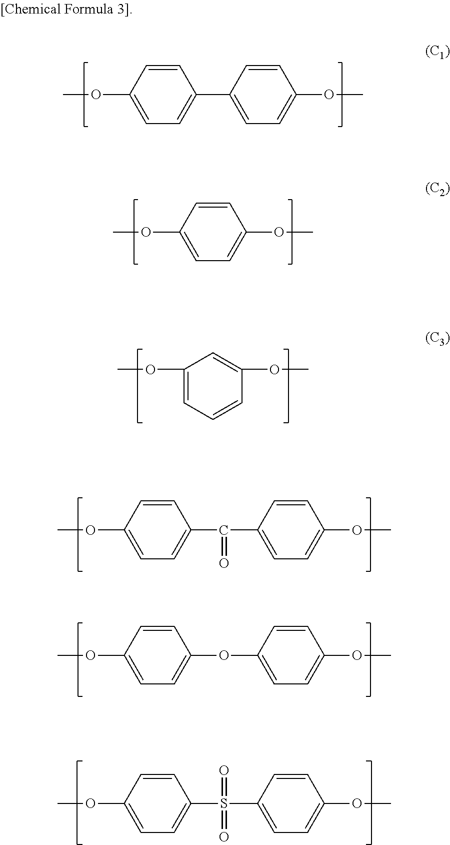

In the structural units, examples of the structural units derived from the aromatic diol also include those having one or more halogen atoms, alkyl groups, or aryl groups as substituents.

It is preferable that the alkyl group be an alkyl group with 1 to 10 carbon atoms, and is more preferable that the alkyl group be a methyl group, an ethyl group, or a butyl group. It is preferable that the aryl group be an aryl group with 6 to 20 carbon atoms.

Liquid crystal polyesters particularly preferable from the point of a balance among heat resistance, mechanical properties, and workability are those containing at least 30 mol % of the (A₁) based on the total content of all the structural units. Specifically, examples of the particularly preferable liquid crystal polyesters include combinations (a) to (h) of structural units below.

(a): A combination of (A₁), (B₁), and (C₁), or a combination of (A₁), (B₁), (B₂), and (C₁).
(b): A combination of (A₂), (B₃), and (C₂), or a combination of (A₂), (B₁), (B₃), and (C₂).
(c): A combination of (A₁) and (A₂).
(d): A combination in which a part or all of (A₁) is replaced by (A₂) in the combination (a) of structural units.
(e): A combination in which a part or all of (B₁) is replaced by (B₃) in the combination (a) of structural units.
(f): A combination in which a part or all of (C₁) is replaced by (C₃) in the combination (a) of structural units.
(g): A combination in which a part or all of (A₂) is replaced by (A₁) in the combination (b) of structural units.
(h): A combination in which (B₁) and (C₂) are added to the combination (c) of structural units.

The liquid crystal polyesters (a) and (b) serving as the most fundamental structure are exemplified in Japanese Examined Patent Application Publication No. 47-47870 and Japanese Examined Patent Application Publication No. 63-3888, respectively.

As the liquid crystal polyester, preferred from the viewpoint of manifestation of liquid crystallinity are those containing 30 to 80 mol % of the structural unit (A₁) derived from p-hydroxybenzoic acid, 10 to 35 mol % of the structural unit (C₂) or (C₁) derived from at least one compound selected from the group consisting of hydroquinone and 4,4′-dihydroxy biphenyl, and 10 to 35 mol % of the structural unit (B₁) or (B₂) derived from at least one compound selected from the group consisting of terephthalic acid and isophthalic acid based on the total content of all the structural units.

As the liquid crystal polyester, those whose flow initiation temperature is preferably 250° C. to 350° C., and more preferably not less than 280° C.

Examples of the production method for a liquid crystal polyester include a method for acylating at least one compound selected from the group consisting of aromatic hydroxycarboxylic acids and aromatic diols with an excessive amount of a fatty acid anhydride to obtain an acylated product, and melt polymerizing by performing transesterification (polycondensation) of the thus-obtained acylated product and at least one compound selected from the group consisting of aromatic hydroxycarboxylic acids and aromatic dicarboxylic acids. As the acylated product, fatty acid esters obtained by acylation in advance may be used.

Acylation and/or transesterification may be performed in the presence of a catalyst. Examples of the catalyst include metal salt catalysts such as magnesium acetate, tin (II) acetate, tetrabutyl titanate, lead acetate, sodium acetate, potassium acetate, and antimony trioxide; and organic compound catalysts such as N,N-dimethylaminopyridine and N-methylimidazole. The catalyst is usually supplied at the time of supplying monomers, and does not always need to be removed after acylation; in the case where the catalyst is not removed, transesterification can be performed successively.

Polycondensation by transesterification is usually performed by melt polymerization, while melt polymerization and solid state polymerization may be used in combination. It is preferable that the solid state polymerization be performed by a known solid state polymerization method after the polymer is extracted after the melt polymerization and pulverized into powder or flakes.

Moreover, a filler and an additive can also be blended with the thermoplastic resin as optional constituents in the range in which the optional constituents do not impair the object of the present invention.

Examples of the filler include plate-like fillers, hollow fillers, fibrous fillers, and spherical fillers.

As the plate-like filler, talc, mica, glass flake, montmorillonite, smectite, graphite, boron nitride, molybdenum disulfide, and the like can be blended. These may be used alone, or two or more thereof may be simultaneously used.

As the hollow filler, Shirasu balloons, glass balloons, ceramic balloons, organic resin balloons, fullerene, and the like can be blended.

As the fibrous filler, glass fibers, carbon fibers, wollastonite, aluminum borate whiskers, potassium titanate whiskers, silica alumina fibers, alumina fibers, and the like can be blended. These may be used alone, or two or more thereof may be used.

As the spherical filler, glass beads, silica beads, and the like can be blended.

On the other hand, as the additive, additives that are usually used in the field, such as a mold release improving agent (for example, fluororesins and metallic soaps), a coloring agent (for example, dyes and pigments), an antioxidant, a thermal stabilizer, an ultraviolet absorbing agent, an antistatic agent, and a surfactant, may be blended.

In addition, an additive having an external lubricant effect such as higher fatty acids, higher fatty acid esters, higher fatty acid metal salts, and fluorocarbon based surfactants may be used.

<Production Method for Ceramic-Resin Composite>

Next, a production method for the ceramic-resin composite 1 formed of the ceramic component 2 and the thermoplastic resin component 3 by using a production method for a ceramic-resin composite according to the embodiment 1 will be described.

The production method of the present invention comprises a welding step of ultrasonically welding a ceramic component and a thermoplastic resin component, wherein at the welding step, at least one of the ceramic component and the thermoplastic resin component has been heated. The production method of the present invention may further comprise a heating step of heating at least one of the ceramic component and the thermoplastic resin component before the welding step.

In the embodiment 1, at the heating step, as illustrated in FIG. 2(a), the ceramic component 2 is placed on an electric heating plate 4, and the electric heating plate 4 is electrically conducted to heat the ceramic component 2 until the ceramic component 2 reaches a predetermined temperature. However, if the temperature of the ceramic component 2 is excessively increased, the thermoplastic resin component 3 may partially melt and deform at the welding step described later when the thermoplastic resin component 3 is pressure contacted with the ceramic component 2. Accordingly, the temperature of the ceramic component 2 is within the range in which the thermoplastic resin component 3 can keep the shape.

At this time, as for the temperature of the ceramic component 2, 50 to 450° C. is preferable. At a temperature of the ceramic component 2 less than 50° C., the ceramic component 2 and the thermoplastic resin component 3 may not be welded to each other. Conversely, at a temperature of the ceramic component 2 exceeding 450° C., a thermoplastic resin that forms the thermoplastic resin component 3 may be decomposed at the welding step described later when the thermoplastic resin component 3 is pressure contacted with the ceramic component 2.

More preferably, the temperature of the ceramic component 2 is selected from the temperature range from the lower limit temperature 100° C. lower than the flow initiation temperature of the thermoplastic resin that forms the thermoplastic resin component 3 to the upper limit temperature 100° C. higher than the flow initiation temperature. For example, if the flow initiation temperature of this thermoplastic resin is 300° C., the ceramic component 2 is heated until the ceramic component 2 reaches 200 to 400° C. Thereby, at the welding step described later, ultrasonic welding of the ceramic component 2 and the thermoplastic resin component 3 is efficiently performed without wastefulness, and simultaneously a state where the thermoplastic resin excessively melts so that the thermoplastic resin component 3 cannot keep the shape can be avoided.

When the ceramic component 2 thus reaches the predetermined temperature, it goes to the welding step. The thermoplastic resin component 3 is ultrasonically welded to the ceramic component 2 while maintaining the heating temperature of the ceramic component 2 as illustrated in FIG. 2(b). For the ultrasonically welding, the thermoplastic resin component 3 is ultrasonically vibrated (friction vibrated) on a predetermined condition (frequency of ultrasonic vibration, welding time) by using an ultrasonic welding machine in the state where the ceramic component 2 is pressure contacted with the thermoplastic resin component 3 at a predetermined pressure.

The ultrasonic welding machines used at this time are classified into a Wedge-lead system and a Lateral Drive system, and both of the systems can be used. However, the Lateral Drive system is preferable in the case where the ceramic component 2 is vulnerable to impact and may be damaged by collision of an oscillator.

A pressure of pressure contact obtained by dividing a pressure by a welding area is preferably 0.5 to 10 MPa; a frequency of ultrasonic vibration is preferably 10 to 40 kHz; and a welding time is preferably 0.01 to 1 second and more preferably 0.05 to 1 second.

Further, the applied energy of ultrasonic vibration may be concentrated by providing a projection part in a joining plane between the thermoplastic resin component 3 and the ceramic component 2. In this case, as for the shape of this projection part, it is preferable that the cross section thereof be triangular such that the leading end thereof is narrower than the base. In the direction perpendicular to the cross section, the shape may be a shape of a long extending line, or may be a shape of a cone or a pyramid separated and isolated. Or the applied energy of ultrasonic vibration may be concentrated by contacting at least one edge or corner of the ceramic component 2 with that of the thermoplastic resin component 3.

When the thermoplastic resin component 3 is ultrasonically welded to the ceramic component 2 in this way, frictional heat is produced in the joining plane between the ceramic component 2 and the thermoplastic resin component 3, and the ceramic component 2 and the thermoplastic resin component 3 are welded to each other by this frictional heat, so that the ceramic-resin composite 1 is obtained.

Here, the production method for a ceramic-resin composite is completed.

Thus, in the production method for a ceramic-resin composite, because one or both of the components are heated at the time of ultrasonic welding of the ceramic component 2 and the thermoplastic resin component 3, the energy needed for this ultrasonic welding can be reduced. As a result, in the ceramic-resin composite 1, joining strength between the ceramic component 2 and the thermoplastic resin component 3 can be increased.

In addition, only the heating step is added to the conventional welding step in order to obtain this ceramic-resin composite 1. Accordingly, unlike the technique proposed in Japanese Unexamined Patent Application Publication No. 2002-237240 mentioned above, it is not necessary to increase the applied energy of ultrasonic vibration for the purpose of improving joining strength of the welding surface; for this reason, the state where the thermoplastic resin excessively melts can be avoided. Therefore, the size of the thermoplastic resin component 3 is not fluctuated, a large amount of burrs is not produced, and dimensional precision of the ceramic-resin composite 1 can be increased.

Moreover, for the same reason, unlike the technique proposed in Japanese Unexamined Patent Application Publication No. 2007-55228 mentioned above, it is not necessary to prepare the ceramic component having a porous region on the surface thereof prior to ultrasonic welding; for this reason, manufacturing cost of the ceramic-resin composite can be reduced.

Further, because the ceramic usually has thermal conductivity higher than that of the thermoplastic resin, the temperature can be increased in a short time in the case where the ceramic component 2 is heated than in the case where the thermoplastic resin component 3 is heated. As a result, the time needed for the heating step can be reduced, and productivity of the ceramic-resin composite 1 can be enhanced eventually.

### Other Embodiments of the Invention

In the embodiment 1 mentioned above, the case where the ceramic component 2 is heated using the electric heating plate 4 at the heating step at the time of producing the ceramic-resin composite 1 has been described. At the time of heating of the ceramic component, heating means other than the electric heating plate 4, for example, a hot plate, a heater for heating, or an infrared irradiation apparatus may be used.

Moreover, in embodiment 1 mentioned above, the case where the ceramic component 2 is heated at the heating step at the time of producing the ceramic-resin composite 1 has been described. However, the thermoplastic resin component 3 may be heated instead of the ceramic component 2, or both the ceramic component 2 and the thermoplastic resin component 3 may be heated. In the case where the thermoplastic resin component 3 is heated, it is preferable that the heating be performed in the temperature range from the lower limit temperature 100° C. lower than the flow initiation temperature of the thermoplastic resin that forms the thermoplastic resin component 3 to the upper limit temperature 10° C. higher than the flow initiation temperature. For example, if the flow initiation temperature of this thermoplastic resin is 300° C., it is preferable that the thermoplastic resin component 3 be heated until the thermoplastic resin component 3 reaches 200 to 310° C. Thereby, at the welding step, ultrasonic welding of the ceramic component 2 and the thermoplastic resin component 3 is efficiently performed without wastefulness, and simultaneously a state where the thermoplastic resin excessively melts so that the thermoplastic resin component 3 cannot keep the shape can be avoided.

### EXAMPLES

Hereinafter, Examples according to the present invention will be described. The present invention will not be limited to Examples.

### Example 1

A 10 mm×50 mm×1 mm alumina ceramic plate (Al₂O₃ content: 96% by mass, sintering aid content: 4% by mass) was fixed to a holder with a screw, and heated to 300° C. by a heater for heating. At this time, it was checked by a contact type surface thermometer that the temperature was stable at a preset temperature.

Next, a part (a surface portion measuring 10 mm×10 mm) of a molded article (10 mm×50 mm×1.6 mm) prepared by molding a liquid crystal polyester “SUMIKASUPER LCP E6006L MR” made by Sumitomo Chemical Co., Ltd. (flow initiation temperature: 326° C.) by injection molding was layered on and contacted with the alumina ceramic plate for 1 minute; then, using an ultrasonic welding machine “2000ea20” made by Emerson Japan, Ltd. (Lateral Drive system, output of 1100 W, vibration applying frequency of 20 kHz, the maximum amplitude of 92 μm), ultrasonic welding was performed on conditions of a pressure of pressure contact of 0.2 to 1 MPa, 70% of the amplitude, a welding time of 0.1 seconds, and a holding time of 0.1 seconds. The pressure of pressure contact has the range because the liquid crystal polyester melts during ultrasonic welding so that the pressure is fluctuated. As a result, the alumina ceramic plate and the molded article of the liquid crystal polyester were welded to each other, so that a ceramic-resin composite was obtained.

The flow initiation temperature of this liquid crystal polyester was measured using a flow tester “CFT-500 type” made by Shimadzu Corporation as follows. Namely, a sample to be measured (liquid crystal polyester) was heated at a temperature raising rate of 4° C./min to form a melt. Then, when this melt was extruded at a load of 9.8 MPa from a nozzle whose inner diameter was 1 mm and length was 10 mm, a temperature at which the melt viscosity of the melt was 4800 Pa·s was measured; this temperature was defined as the flow initiation temperature.

### Example 2

The alumina ceramic plate and the molded article of the liquid crystal polyester were ultrasonically welded to each other by the same method as that in Example 1 mentioned above except that the conditions of ultrasonic welding were an amplitude of 50%, a welding time of 0.07 seconds, and a holding time of 0.05 seconds. As a result, the alumina ceramic plate and the molded article of the liquid crystal polyester were welded to each other, so that a ceramic-resin composite was obtained.

### Example 3

The alumina ceramic plate and the molded article of the liquid crystal polyester were ultrasonically welded to each other by the same method as that in Example 2 mentioned above except that the heating temperature of the alumina ceramic plate by the heater for heating was 350° C. As a result, the alumina ceramic plate and the molded article of the liquid crystal polyester were welded to each other, so that a ceramic-resin composite was obtained.

### Example 4

The alumina ceramic plate and the molded article of the liquid crystal polyester were ultrasonically welded to each other by the same method as that in Example 1 mentioned above except that the heating temperature of the alumina ceramic plate by the heater for heating was 250° C. As a result, the alumina ceramic plate and the molded article of the liquid crystal polyester were welded to each other, so that a ceramic-resin composite was obtained.

### Example 5

The alumina ceramic plate and the molded article of the liquid crystal polyester were ultrasonically welded to each other by the same method as that in Example 1 mentioned above except that the conditions of ultrasonic welding were an amplitude of 50%, a welding time of 0.05 seconds, and a holding time of 0.01 seconds, the heating temperature of the alumina ceramic plate by the heater for heating was 375° C. As a result, the alumina ceramic plate and the molded article of the liquid crystal polyester were welded to each other, so that a ceramic-resin composite was obtained.

### Comparative Example 1

The alumina ceramic plate and the molded article of the liquid crystal polyester were ultrasonically welded to each other by the same method as that in Example 1 mentioned above except that the alumina ceramic plate was not heated. However, the alumina ceramic plate and the molded article of the liquid crystal polyester were not welded to each other, so that a ceramic-resin composite could not be obtained.

### Example 6

The alumina ceramic plate and the molded article of the liquid crystal polyester were ultrasonically welded to each other by the same method as that in Example 1 mentioned above except that the conditions of ultrasonic welding were an amplitude of 70%, a welding time of 0.1 seconds, and a holding time of 0.1 seconds, the alumina ceramic plate was not heated, and the mold article of the liquid crystal polyester was heated at a heating temperature of 300° C. by the heater for heating. As a result, the alumina ceramic plate and the molded article of the liquid crystal polyester were welded to each other, so that a ceramic-resin composite was obtained.

<Measurement of Welding Strength (Joining Strength)>

Using a universal testing machine “Autograph AG-50” made by Shimadzu Corporation, a tensile shearing test of the ceramic-resin composite was performed in each of these Examples 1 to 6 under the conditions of a distance between chucks of 50 mm and a crosshead rate of 1 mm/min. Then, the value obtained by dividing a maximum point stress at this time by a welding area was defined as welding strength (unit: MPa). The results are collectively shown in Table 1.

TABLE 1

| | | | Temperature of | Welding | | Welding | | Heating |
|---|---|---|---|---|---|---|---|---|
| | | | ceramic component | strength | Amplitude | time | Holding time | temperature |
| | Ceramic component | Thermoplastic resin | (° C.) | (MPa) | (%) | (s) | (s) | (° C.) |
| Example 1 | Alumina ceramic | Liquid crystal polyester | 300 | 3.8 | 70 | 0.1 | 0.1 | 300 |
| Example 2 | Alumina ceramic | Liquid crystal polyester | 300 | 0.4 | 50 | 0.07 | 0.05 | 300 |
| Example 3 | Alumina ceramic | Liquid crystal polyester | 350 | 11.6 | 50 | 0.07 | 0.05 | 350 |
| Comparative | Alumina ceramic | Liquid crystal polyester | 23 | Not welded | 70 | 0.1 | 0.1 | 23 |
| Example 1 | | | | | | | | |
| Example 4 | Alumina ceramic | Liquid crystal polyester | 250 | 1.2 | 70 | 0.1 | 0.1 | 250 |
| Example 5 | Alumina ceramic | Liquid crystal polyester | 375 | 12.8 | 50 | 0.05 | 0.01 | 375 |
| Example 6 | Alumina ceramic | Liquid crystal polyester | 300 | 0.8 | 70 | 0.1 | 0.1 | 300 |

Apparently from Table 1, in Comparative Example 1, the ceramic-resin composite could not be obtained. Contrary to this, in Examples 1 to 6, the ceramic-resin composite could be obtained by ultrasonic welding, and the welding strength was 0.4 to 12.8 MPa. Accordingly, in Examples 1 to 6, obtained ceramic-resin composite have high joining strength between the alumina ceramic plate to the molded article of the liquid crystal polyester.

The present invention can be applied to production of a ceramic-resin composite used for electric and electronic components, auto parts, and other applications.

What is claimed is:

1. A production method for a ceramic-resin composite, comprising a welding step of ultrasonically welding a ceramic component and a thermoplastic resin component,
wherein at the welding step, at least one of the ceramic component and the thermoplastic resin component has been heated.

2. The method according to claim 1, wherein at the welding step, the ceramic component has been heated within a temperature range from a lower limit temperature 100° C. lower than a flow initiation temperature of a thermoplastic resin that forms the thermoplastic resin component to an upper limit temperature 100° C. higher than the flow initiation temperature.

3. The method according to claim 1, wherein at the welding step, the thermoplastic resin component has been heated within a temperature range from a lower limit temperature 100° C. lower than the flow initiation temperature of a thermoplastic resin that forms the thermoplastic resin component to an upper limit temperature 10° C. higher than the flow initiation temperature.

4. The method according to claim 1, wherein a flow initiation temperature of a thermoplastic resin that forms the thermoplastic resin component is 250 to 350° C.

5. The method according to claim 2, wherein the flow initiation temperature of the thermoplastic resin that forms the thermoplastic resin component is 250 to 350° C.

6. The method according to claim 3, wherein the flow initiation temperature of the thermoplastic resin that forms the thermoplastic resin component is 250 to 350° C.

7. The method according to claim 1, wherein the thermoplastic resin component is formed of a liquid crystal polyester.

8. The method according to claim 2, wherein the thermoplastic resin component is formed of a liquid crystal polyester.

9. The method according to claim 3, wherein the thermoplastic resin component is formed of a liquid crystal polyester.

10. The method according to claim 4, wherein the thermoplastic resin component is formed of a liquid crystal polyester.

11. The method according to claim 5, wherein the thermoplastic resin component is formed of a liquid crystal polyester.

12. The method according to claim 6, wherein the thermoplastic resin component is formed of a liquid crystal polyester.
